(19) United States
(12) Patent Application Publication
(10) Pub. No.: US 2025/0299047 A1
(43) Pub. Date: Sep. 25, 2025

(54) METHOD AND SYSTEM FOR COMPRESSING AND TUNING LARGE LANGUAGE MODELS

(71) Applicant: L&T TECHNOLOGY SERVICES LIMITED, Chennai (IN)

(72) Inventors: SUDHIR BHADAURIA, Ahmedabad (IN); VIKRAM SUBRAMANI, Krishnagiri (IN)

(21) Appl. No.: 18/660,267

(22) Filed: May 10, 2024

(30) Foreign Application Priority Data
Mar. 22, 2024 (IN) 202441022184

(51) Int. Cl. G06N 3/0895

(52) U.S. Cl. CPC G06N 3/0895

(57) ABSTRACT

A method and a system of compressing and tuning large language models is disclosed. A processor 104 receives an LLM, a pruning ratio, an initial rank, and a set of target layers from a plurality of layers of the LLM. A dependency-wise pruning is performed of the LLM based on the pruning ratio. A rank-based factorization of the LLM is performed based on the initial rank to generate factorized weights. A pruned LLM is determined based on the dependency-wise pruning. The pruned LLM is updated by injecting one or more additional layers to one or more corresponding layers of the pruned LLM to generate a compressed LLM. The compressed LLM is fine-tuned for a specific domain or for a specific task by fine-tuning the factorized weights for the additional layers of the compressed LLM based on the domain-specific training data or task-specific training data.

### TECHNICAL FIELD

This disclosure relates generally to model compression and fine tuning and more particularly to a method and system for compression and tunning large language models.

### BACKGROUND

Large language models (LLMs) have become increasingly popular in various tasks which include natural language processing (NLP). Some examples of tasks include machine translation, text generation, question answering, etc. The LLMs are required to be trained using a vast amount of dataset to perform several tasks. Based on the training, the internal variables (or “weights”) are adjusted, which is instrumental in determining how the model responds to inputs. Accordingly, the LLMs tend to increase in size based on the parameters (or “weights”). For example, models, such as GPT-3 and BERT are trained on massive amounts of data and have millions or even billions of parameters.

The formidable size and computational requirements of the LLMs present significant challenges in the practical application, especially in limited computational resource environments. Large LLMs require substantial memory and storage resources and such resource extensive requirements limit their deployment on devices which lack infrastructure like smart phones or IoT devices. Training of LLMs enhances its computational power however it may also impact its speed of inference, and eventually may result in longer response time. Further, LLMs may consume substantial amounts of energy while training of the model which may add to the operational cost and makes LLM unsustainable. Moreover, deployment of LLMs over the internet or in cloud-based environments can be challenging due to limited bandwidth and increased network latency. Pruning of the LLMs is a solution that may reduce the size of the model. However, pruning may also impact the computational power of the LLMs.

Therefore, there is a requirement for a methodology to make LLMs efficient with respect to resources, computational power, speed, and deployment.

### SUMMARY OF THE INVENTION

In an embodiment, a method of compressing and tuning large language model (LLM) is disclosed. The method may include receiving, by a model compression and tuning device, an LLM, a pruning ratio, an initial rank, and a set of target layers from a plurality of layers of the LLM. The method may further include performing, by the model compression and tuning device, a dependency-wise pruning of the LLM based on the pruning ratio to generate a pruned LLM. Further the method may include, performing, by the model compression and tuning device, a rank-based factorization of the LLM based on the initial rank to generate factorized weights for each of the set of target layers of the LLM. Further, the method may include updating, by the model compression and tuning device, the pruned LLM by injecting one or more additional layers to one or more corresponding layers of the pruned LLM to generate a compressed LLM. In an embodiment the one or more additional layers are based on the factorized weights for each of the set of target layers of the LLM.

In another embodiment, a system of compressing and tuning large language model (LLM) is disclosed. The system may include a processor and a memory communicably coupled to the processor, wherein the memory may store processor-executable instructions, which when executed by the processor may cause the processor to receive an LLM, a pruning ratio, an initial rank, and a set of target layers from a plurality of layers of the LLM. Further the processor may perform a dependency-wise pruning of the LLM based on the pruning ratio to generate a pruned LLM. The processor may further perform a rank-based factorization of the LLM based on the initial rank and pruning ratio to generate factorized weights for each of the set of target layers of the LLM. The processor may further update the pruned LLM by injecting one or more additional layers to one or more corresponding layers of the pruned LLM to generate a compressed LLM. In an embodiment the one or more additional layers are based on the factorized weights for each of the set of target layers of the LLM.

### BRIEF DESCRIPTION OF THE DRAWING

FIG. 1 illustrates a block diagram of an exemplary model compression and tuning system for large language models, in accordance with an embodiment of the present disclosure.

FIG. 2 illustrates a block diagram of a computing device, in accordance with an embodiment of the present disclosure.

FIG. 3 illustrates an exemplary LLM, in accordance with an embodiment of the present disclosure.

FIG. 4 illustrates a flow diagram of a methodology of compressing and tuning the large language models, in accordance with an embodiment of present disclosure.

### DETAILED DESCRIPTION OF THE DRAWINGS

Exemplary embodiments are described with reference to the accompanying drawings. Wherever convenient, the same reference numbers are used throughout the drawings to refer to the same or like parts. While examples and features of disclosed principles are described herein, modifications, adaptations, and other implementations are possible without departing from the scope of the disclosed embodiments. It is intended that the following detailed description be considered exemplary only, with the true scope being indicated by the following claims. Additional illustrative embodiments are listed.

Further, the phrases “in some embodiments”, “in accordance with some embodiments”, “in the embodiments shown”, “in other embodiments”, and the like mean a particular feature, structure, or characteristic following the phrase is included in at least one embodiment of the present disclosure and may be included in more than one embodiment. In addition, such phrases do not necessarily refer to the same embodiments or different embodiments. It is intended that the following detailed description be considered exemplary only, with the true scope being indicated by the following claims.

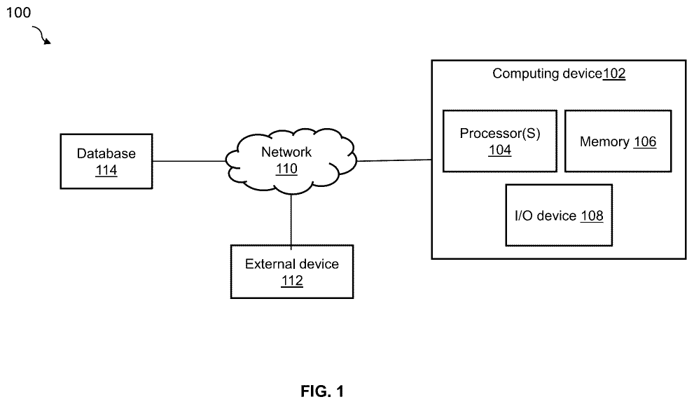

Referring now to FIG. 1, a block diagram of an exemplary model compression and tuning system 100 for large language models is illustrated, in accordance with an embodiment of the present disclosure. The model compression and tuning system 100 may include a computing device 102 also referred hereinafter as model compression and tuning device 102, an external device 112, and a database 114 communicably coupled to each other through a wired or wireless communication network 110. The computing device may include a processor 104, a memory 106 and an input/output (I/O) device 108.

In an embodiment, examples of processor(s) 104 may include, but are not limited to, an Intel® Itanium® or Itanium 2 processor(s), or AMD® Opteron® or Athlon MP® processor(s), Motorola® lines of processors, Nvidia®, FortiSOC™, system on a chip processors or other future processors.

In an embodiment, the memory 106 may store instructions that, when executed by the processor 104, and cause the processor 104 to compress and tune the large language models, as discussed in more details below. In an embodiment, the memory 106 may be a non-volatile memory or a volatile memory. Examples of non-volatile memory may include but are not limited to, a flash memory, a Read Only Memory (ROM), a Programmable ROM (PROM), Erasable PROM (EPROM), and Electrically EPROM (EEPROM) memory. Further, examples of volatile memory may include but are not limited to, Dynamic Random Access Memory (DRAM), and Static Random-Access memory (SRAM).

In an embodiment, the I/O device 108 may comprise of variety of interface(s), for example, interfaces for data input and output devices, and the like. The I/O device 108 may facilitate inputting of instructions by a user communicating with the computing device 102. In an embodiment, the I/O device 108 may be wirelessly connected to the computing device 102 through wireless network interfaces such as Bluetooth®, infrared, or any other wireless radio communication known in the art. In an embodiment, the I/O device 108 may be connected to a communication pathway for one or more components of the computing device 102 to facilitate the transmission of inputted instructions and output results of data generated by various components such as, but not limited to, processor(s) 104 and memory 106.

In an embodiment, the database 114 may be enabled in a cloud or a physical database and may store historical data, and/or training data. In an embodiment, the database 114 may store data input by an external device 112 or output generated by the computing device 102.

In an embodiment, the communication network 110 may be a wired or a wireless network or a combination thereof. The network 110 can be implemented as one of the different types of networks, such as but not limited to, ethernet IP network, intranet, local area network (LAN), wide area network (WAN), the internet, Wi-Fi, LTE network, CDMA network, 5G and the like. Further, network 110 can either be a dedicated network or a shared network. The shared network represents an association of the different types of networks that use a variety of protocols, for example, Hypertext Transfer Protocol (HTTP), Transmission Control Protocol/Internet Protocol (TCP/IP), Wireless Application Protocol (WAP), and the like, to communicate with one another. Further network 110 can include a variety of network devices, including routers, bridges, servers, computing devices, storage devices, and the like.

In an embodiment, the computing device 102 may receive an LLM, a pruning ratio, an initial rank, and a set of target layers from a plurality of layers of the LLM from the external device 112 through the network 110. In an embodiment, the computing device 102 and the external device 112 may be a computing system, including but not limited to, a laptop computer, a desktop computer, a notebook, a workstation, a portable computer, a handheld or a mobile device. In an embodiment, the computing device 102 may be, but not limited to, in-built into the external device 112 or may be a standalone computing device.

In an embodiment, the computing device 102 may perform various processing in order to compress and tune the large language model. By way of an example, the computing device 102 may receive an LLM, a pruning ratio for the LLM that is to be pruned for example (if 30% of model parameters has to be reduced then the 30% is the pruning ratio), an initial rank to compress factorized weights, and a set of target layers from a plurality of layers of the LLM as input by a user. In an embodiment, the LLM may include a pre-trained LLM for a specific domain or for a specific task. In an embodiment the target layers may include the layers of the LLM that may be factorized for domain specific tuning of the LLM. In an embodiment, examples of the LLM may include, but are not limited to, zephyr, code LLAMA, GPT, etc.

Further, the computing device 102 may further perform a dependency-wise pruning of the LLM based on the pruning ratio that may have been received from the user to generate a pruned LLM. In an embodiment, to perform the dependency-wise pruning, the computing device 102 may group dependent layers from the plurality of the layers of the LLM, based on one or more parameters, into a set of groups. Further, to perform dependency-wise pruning the computing device 102 may determine a similarity between each of the set of groups based on a cosine distance among them. In an embodiment, the determination of similarity using cosine distance may include calculation of cosine angles between each group parameter vectors, representing similarity between them. Further, the computing device 102 may determine a number of connections to be pruned from each of the set of groups based on the similarity and the pruning ratio. In an embodiment, the number of connections to be pruned may be removed by the computing device 102, by pruning the LLM in order to achieve a pruned model.

The computing device 102 may further perform a rank-based factorization of the LLM based on the initial rank and pruning ratio input by the user, to generate a compressed factorized weights for each of the set of target layers of the LLM. In an embodiment, the rank-based factorization may include breaking or decomposition of an entity, (for example a number, a matrix, or a polynomial) into a product of a single value or entity, or factors, which when multiplied together may provide the original number or a matrix, etc.

In an embodiment, to perform rank-based factorization the computing device 102 may apply a singular value decomposition on each of the set of target layers inputted by the user to generate singular value decomposition matrices (SVDMs) for each of the set of targeted layers. In an embodiment, the (SVDMs) may include initial factorized weights for a given layer. In an embodiment, the (SVDMs) may be a mathematical technique used to decompose a matrix into other matrices, providing a way to represent and analyze the original matrix's structure. Further, the (SVDMs) may retain most significant values and vectors, effectively reducing the dimensionality of the weights.

Further, to perform rank-based factorization the computing device 102 may determine a rank for each of the set of target layers based on application of a pre-defined algorithm on singular values from the corresponding SVDMs. In an embodiment, the singular values are arranged in a ranked order. In an embodiment, the predefined algorithm may include knee point detection algorithm. In an embodiment the ranked order in which the singular value may be arranged may be a descending order of the singular values. Further, to perform rank-based factorization, the computing device 102 may normalize the rank for each of the set of the target layers based on the initial rank to determine the factorized weights for each of the set of target layers of the LLM. Further, the factorized weights may be down-sampled for each of the set of target layers of the LLM based on the pruning ratio to compress the factorized weights for each of the set of layers of the LLM. In an embodiment, the compressed factorized weights serve as the starting point for the model to learn and adjust through the training data.

In an embodiment, the dependency-wise pruning and the rank-based factorization may be performed simultaneously and parallel to obtain compression and to get the optimal factorized weights for each layer. Further, the computing device 102 may update the pruned LLM by injecting one or more additional layers to one or more corresponding layers of the pruned LLM to generate a compressed LLM. In an embodiment, the one or more additional layers are based on the factorized weights for each of the set of target layers of the LLM. In an embodiment, the computing device 102 may update the pruned LLM by generating an initial output for each of the one or more corresponding layers of the pruned LLM. Further, the computing device 102 may generate an additional output for each of the one or more additional layer. Accordingly, to update the pruned LLM, the computing device 102 may determine an output for each of the one or more corresponding layers of the pruned LLM based on the initial output and the additional output. Accordingly, once the pruned model and the factorized weights are obtained the factorized weights may be fused with the corresponding layer of the pruned model.

Further, the computing device 102 may fine tune the compressed LLM for a specific domain or for a specific task by fine-tuning the factorized weights for the one or more additional layers of the compressed LLM based on domain-specific training data or task-specific training data respectively. It is to be noted that the fine-tuning of the compressed LLM may generate a finetuned compressed LLM. Further, the domain specific fine-tuning may reduce the trainable parameters of the compressed LLM model compared to the conventional fine tuning. In an embodiment, the computing device 102 may apply fine-tuning on the compressed LLM to adapt it for the specific task. While fine-tuning only the factorized weights for the target layers will be updated and weights of the pruned LLM for layers other than the target layers are frozen or unchanged.

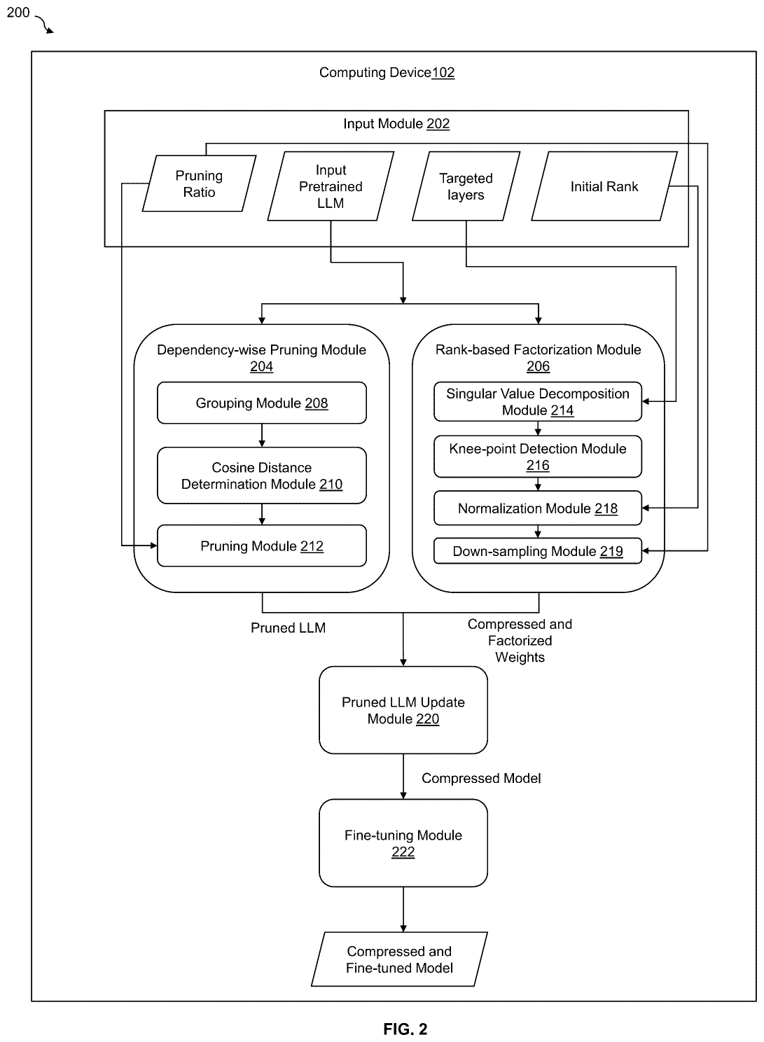

Referring now to FIG. 2, a block flow diagram 200 of the computing device 102 is illustrated, in accordance with an embodiment of the present disclosure. In an embodiment, the computing device 102 may include an input module 202, a dependency-wise pruning module 204, a rank-based factorization module 206, a pruned LLM update module 208, and a fine-tuning module 210.

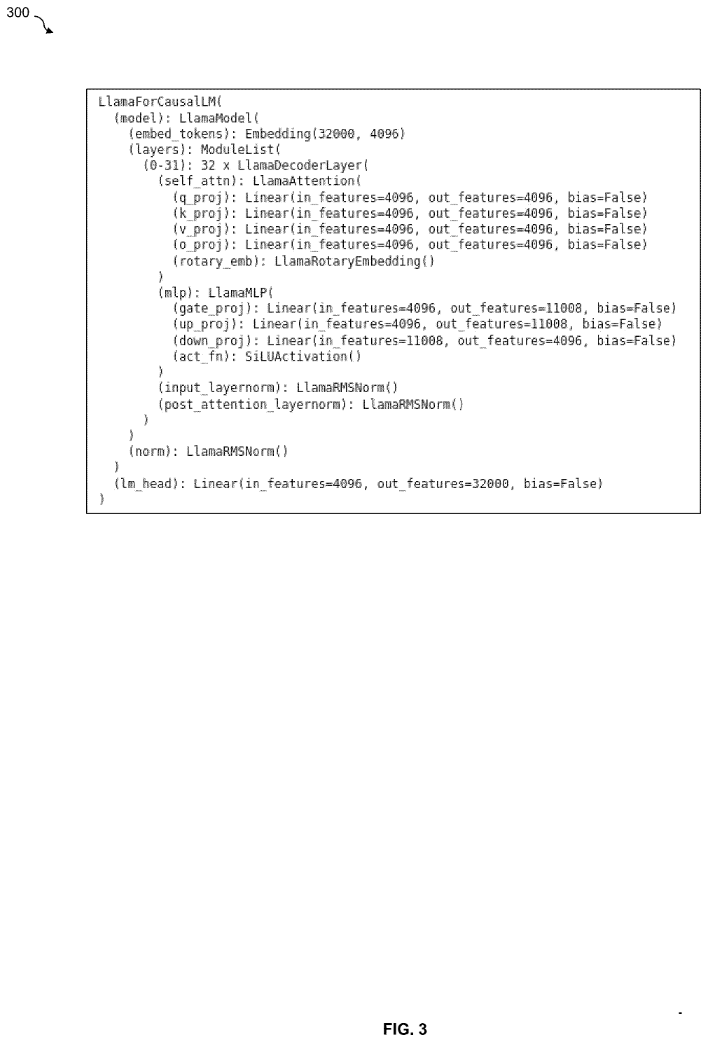

The input module 202 may receive as a user input from a user via the I/O device 108, an LLM, a pruning ratio, an initial rank, and a set of target layers from a plurality of layers of the LLM. In an embodiment, the LLM may be a pre-trained LLM for a specific domain or for a specific task. FIG. 3 illustrates an exemplary LLM 300, in accordance with an embodiment of the present disclosure. The LLM 300 input by the user may be pruned and fine-tuned by the computing device 102 in accordance with the methodology of the present disclosure. In an embodiment, examples of the LLM may include, but are not limited to, zephyr, code LLAMA, GPT, etc.

Further, in an embodiment the pruning ratio input by the user may depict a ratio by which the LLM is to be pruned. For example, for a pruning ratio of 30%, 30% of model parameters may be deleted to prune the LLM. Further in an embodiment, the set of target layers may include the layers of the LLM that are to be fine-tuned based on the specific domain or the specific task.

The dependency-wise pruning module 204 may perform the dependency-wise pruning of the LLM based on the pruning ratio input by the user. The dependency-wise pruning module 204 may include a grouping module 208, a cosine distance determination module 210 and a pruning module 212. LLM in general may include attention module accordingly, the layers of the LLM may be dependent on each other. The dependency of one layer on another layer may be determined based on the structure analysis. Accordingly, the grouping module 208 may group all the layers of the LLM into a set of groups based on layer analysis being processed. It is to be noted that each of the set of groups may include dependent layers that may be dependent on each other based on computational relationship. Accordingly, individual pruning of such layers may disorient the computational relationship between the dependent layers of a group from the set of groups and may adversely impact the computational accuracy of the LLM.

Further, the cosine determination module 210 may determine a similarity between each of the set of groups based on a cosine distance among them. In an embodiment, the determination of similarity using cosine distance may include calculation of cosine angles between common parameter vectors between each of the set of groups. In one embodiment, the cosine distance representing similarity among the common parameters of each the set of groups may be in a range of 0 to 2. The score of ‘2’ may indicate the common parameter vectors of each of the group from the set of groups are not identical and have perfect dissimilarity. Further, a score of ‘0’ may indicate the common parameter vectors are identical and have perfect similarity.

Further, the pruning module 212 may arrange each of the set of groups based on a descending order of similarity between each of them. Further, the pruning module 212 may prune a number of common parameters between the set of groups based on the pruning ratio. Accordingly, pruning module 212 may determine a number of connections to be pruned from each of the set of groups based on the cosine similarity and the pruning ratio. In an embodiment, the number of parameters to be pruned may be calculated from each of the set of groups based on cosine distance and the pruning ratio. Accordingly, the pruning module 212 may output a pruned LLM.

Further, the rank-based factorization module 206 may perform the rank-based factorization of the LLM based on the initial rank to generate factorized weights for each of the set of target layers of the LLM. The rank-based factorization module 206 may include a singular value decomposition module 214, a knee-point detection module 216 and a normalization module 218 and a down-sampling module 219. The singular value decomposition module 214 may factorize weight matrices of each of the target layers of the LLM. In an embodiment, the weight matrices of each of the target layers may be factorized into a plurality of smaller matrices which when multiplied together may result into the original weight matrix. In an embodiment, the plurality of smaller matrices may be generated using singular value decomposition on the weight matrix of each of the target layers.

In an embodiment, the singular value decomposition module 214 may apply a singular value decomposition on each of the set of target layers to generate singular value decomposition matrices (SVDMs) for each of the set of target layers. In an embodiment, the target layers may refer to specific layers within the LLM that are identified for factorization by the user. In an embodiment, the singular value decomposition may be a mathematical technique used to decompose a weight matrix (W_{(m×n)}) of a target layer to generate singular value decomposition matrices (SVDMs) (U_{(m×m)}, Σ_{(n×n)}, V_{(n×n)}) for the corresponding target layer. It is to be noted annotations (m×n), (n×n) and (n×n) are indicative of a number of rows and columns in each of the matrices). In an embodiment, the SVDMs may represent the original matrix's structure and may provide way to analyze the same. Further, the (SVDMs) may include at least one singular value matrix (SVM) (Σ_{(n×n)}) including singular values representative of the most significant singular values and vectors, effectively reducing the dimensionality of the weights of a target layer.

Further, the knee-point detection module 216 may determine a rank for each of the set of target layers based on application of a pre-defined algorithm on singular values from the corresponding SVMs (Σ_{(n×n)}). In an embodiment, the singular values may be arranged in a ranked order. Further in an embodiment, the ranked order may be a descending order of their values. In an embodiment, the pre-defined algorithm may include a knee point detection algorithm to detect the rank value based on sorting of the SVM for a target layer in a descending order. A knee-point may be determined based on an elbow method. The knee-point may be representative of an optimal singular value for a corresponding target layer.

Further, the normalization module 218 may normalize the rank for each of the set of target layers based on the initial rank to determine the factorized weights for each of the set of target layers of the LLM. The normalization module 218 may determine a normalization factor based on a product of the initial rank and a number of target layers (n) divided by the sum of the optimal singular value for each of the target layers. In an exemplary embodiment, if the number of target layers is equal to three and the initial rank (rᵢ) as input by the user is 8. Further, if the optimal singular values for each of the three target layers as determined by the knee-point detection module 216 are S1, S2, S3. The normalization module 218 may determine a normalization factor (N) based on following formula (1):

$$N = \frac{ri * n}{( S 1 + S 2 + S 3 )} \qquad ( 1 )$$

Further, the normalization module 218 may determine the rank (r) for each of the set of target layers based on a product of the normalization factor with the corresponding optimal singular value for each of the set of target layers. In an embodiment, the rank (r) may be determined for each of the target layers based on following formula (2):

$${r}_{n} = Sn * N \qquad ( 2 )$$

The down-sampling module 219 may down-sample the factorized weights for each of the set of target layers of the LLM based on the pruning ratio to compress the factorized weights for each of the set of layers of the LLM to determine the compresses factorized weights.

Accordingly, the rank-based factorization module 206 may reduce the size of the SVDMs (U_{(m×m)}, V_{(n×n)}) based on the rank(s) determined for each of the target layer. In an embodiment, the (U_{(m×m)}, V_{(n×n)}) may be compressed to (U_{(m×r)}, V_{(r×n)}) for each of the target layers based on its corresponding rank. Accordingly, the factorized weights for each of the target layers may be determined based on the compressed matrices (U_{(m×r)}, V_{(r×n)}).

As can be seen, the computing device 102 may enable the pruning module 210 and the rank-based factorization module 206 simultaneously and in parallel. Accordingly, the dependency-wise pruning and the rank-based factorization may be performed simultaneously and in parallel.

The pruned LLM update module 220 may update the pruned LLM output by the dependency-wise pruning module 204 by injecting one or more additional layers to one or more corresponding layers of the pruned LLM to generate a compressed LLM. In an embodiment, the one or more additional layers are based on the factorized weights determined by the rank-based factorization module 206 for each of the set of the target layers of the LLM. In an embodiment, the pruned LLM update module 220 may generate the initial output for each of the one or more corresponding layers of the pruned LLM. Further the pruned LLM update module 220 may generate an additional output for each of the one or more additional layers. The pruned LLM update module 220 may determine an output for each of the one or more corresponding layers of the pruned LLM based on the initial output and the additional output. In an embodiment, the output determined may be based on adding additional output parallelly to the corresponding initial output.

The fine-tuning module 222 may fine tune the compressed LLM for a specific domain or for a specific task by fine-tuning the factorized weights for the one or more additional layers of the compressed LLM based on the domain-specific training data or task-specific training data respectively. In an embodiment, the fine-tuning module 210 may perform fine tuning on the compressed LLM to adapt it for the specific task and only the factorized weights may be updated for specific task while the pruned weights will be frozen. In an embodiment, the factorized weights may be fine-tuned based on calculation of a loss and updating the factorized weights based on backpropagation techniques. Accordingly, the fine-tuning module 222 may output a compressed and fine-tuned LLM for the domain-specific training data or task-specific training data.

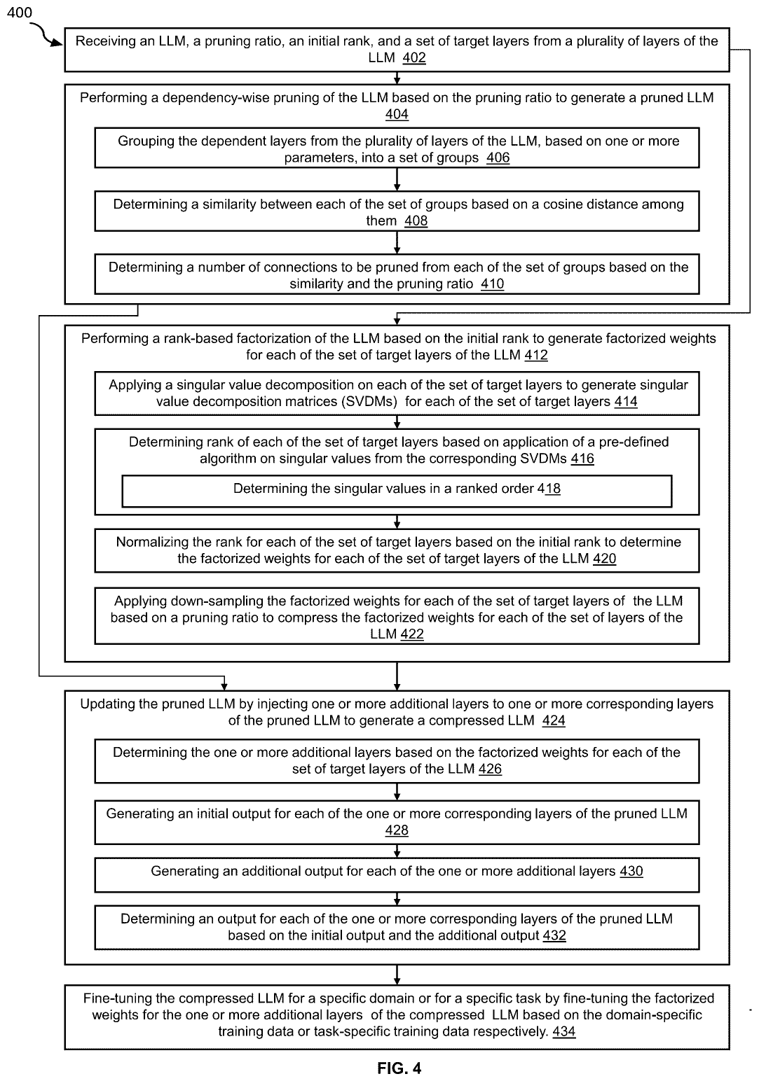

Referring to FIG. 4, a flow diagram 400 of a methodology of compressing and tuning an LLM, in accordance with an embodiment of present disclosure is illustrated. In an embodiment, the flow diagram 400 may include a plurality of steps that may be performed by the processor 104 to determine a compressed and a fine-tuned LLM.

At step 402, an LLM, a pruning ratio, an initial rank, and a set of target layers from a plurality of layers of the LLM may be received from a user for compressing and tuning the LLM for a specific domain or a domain specific task. In an embodiment, examples of the LLM may include, but are not limited to, zephyr, code LLAMA, GPT, etc.

Further at step 404, the computing device 102 may perform a dependency-wise pruning of the LLM based on the pruning ratio to generate a pruned LLM. In an embodiment, the computing device 102 may perform dependency-wise pruning of the LLM based on sub-steps 406-410. At sub-step 406, the dependent layers from the plurality of layers of the LLM may be grouped into a set of groups, based on one or more parameters. Further, at sub-step 408, a similarity between each of the set of groups may be determined based on a cosine distance among them. In an embodiment, the determination of similarity using cosine distance may include calculation of cosine angles between each group parameter vectors, representing similarity among the parameters. The result of cosine distance may be a score in a range of 0 to 2. The score of ‘2’ may indicate the parameter vectors are not identical and have perfect dissimilarity, while the score of ‘0’ may indicate the parameters vectors are identical and have perfect similarity. Further, at sub-step 410 a number of connections to be pruned from each of the set of groups based on the similarity and the pruning ratio may be determined.

Further at step 412, the computing device 102 may perform a rank-based factorization of the LLM based on the initial rank to generate factorized weights for each of the set of target layers of the LLM. In an embodiment, the rank-based factorization may be a technique used to decompose certain weight matrices in the LLM into lower-rank approximations, reducing the overall model size and computational requirements. In an embodiment, the computing device 102 may perform rank-based factorization of the LLM based on sub-steps 414-422. At sub-step 414, the computing device 102 may apply a singular value decomposition on each of the set of target layers to generate singular value decomposition matrices (SVDMs) for each of the set of target layers. Further, at sub-step 416a rank for each of the set of target layers may be determined based on application of a pre-defined algorithm on singular values from the corresponding SVDMs. In an embodiment, the pre-defined algorithm may include a knee point detection algorithm to detect the rank value. Further, at sub-step 418 the singular values are arranged in a ranked order. In an embodiment, at sub-step 420 the computing device 102 may normalise the rank for each of the set of target layers based on the initial rank to determine the factorized weights for each of the set of target layers of the LLM. Further, at sub-step 422 the factorized weights may be down-sampled for each of the set of target layers of the LLM based on the pruning ratio to compress the factorized weights for each of the set of target layers of the LLM.

Further, at step 424, the pruned LLM, determined based on the dependency-wise pruning of the LLM at step 404, may be updated by injecting one or more additional layers to one or more corresponding layers of the pruned LLM to generate a compressed LLM. Further, the computing device 102 may update the pruned LLM based on sub-steps 424-432. Accordingly, at sub-step 426 the one or more additional layers may be determined based on the factorized weights for each of the set of target layers of the LLM. At sub-step 428, an initial output for each of the one or more corresponding layers of the pruned LLM may be generated. At sub-step 430, an additional output for each of the one or more additional layers may be generated. At sub-step 432 an output for each of the one or more corresponding layers of the pruned LLM based on the initial output and the additional output may be determined.

Further at step 434, the compressed LLM determined at step 424, may be fine-tuned for a specific domain or for a specific task by fine-tuning the factorized weights for the one or more additional layers of the compressed LLM based on the domain-specific training data or task-specific training data respectively.

As will be appreciated by those skilled in the art, the techniques described in the various embodiments discussed above are not routine, or conventional, or well-understood in the art. The techniques discussed above provide for compressing and tuning the large language model.

In light of the above-mentioned advantages and the technical advancements provided by the disclosed method and system, the claimed steps as discussed above are not routine, conventional, or well understood in the art, as the claimed steps enable the following solutions to the existing problems in conventional technologies. Further, the claimed steps bring an improvement in the functioning of the device itself as the claimed steps provide a technical solution to a technical problem.

The specification has described the method and system for compressing and tuning the large language models. The illustrated steps are set out to explain the exemplary embodiments shown, and it should be anticipated that ongoing technological development will change the manner in which particular functions are performed. These examples are presented herein for the purpose of illustration, and not limitation. Further, the boundaries of the functional building blocks have been arbitrarily defined herein for the convenience of the description. Alternative boundaries can be defined so long as the specified functions and relationships thereof are appropriately performed. Alternatives (including equivalents, extensions, variations, deviations, etc., of those described herein) will be apparent to persons skilled in the relevant art(s) based on the teachings contained herein. Such alternatives fall within the scope and spirit of the disclosed embodiments.

It is intended that the disclosure and examples be considered as exemplary only, with a true scope of disclosed embodiments being indicated by the following claims.

What is claimed is:

1. A method of compressing and tuning a large language model (LLM), the method comprising:
receiving, via a model compression and tuning device, an LLM, a pruning ratio, an initial rank, and a set of target layers from a plurality of layers of the LLM;
performing, via the model compression and tuning device, a dependency-wise pruning of the LLM based on the pruning ratio to generate a pruned LLM;
performing, via the model compression and tuning device, a rank-based factorization of the LLM based on the initial rank to generate factorized weights for each of the set of target layers of the LLM; and
updating, via the model compression and tuning device, the pruned LLM by injecting one or more additional layers to one or more corresponding layers of the pruned LLM to generate a compressed LLM,
wherein the one or more additional layers are based on the factorized weights for each of the set of target layers of the LLM.

2. The method of claim 1, comprising:
fine-tuning, via a model compression and tuning device, the compressed LLM for a specific domain or for a specific task by fine-tuning the factorized weights for the one or more additional layers of the compressed LLM based on domain-specific training data or task-specific training data respectively.

3. The method of claim 1, wherein performing the dependency-wise pruning comprises:
grouping, via the model compression and tuning device, dependent layers from the plurality of layers of the LLM, based on one or more parameters, into a set of groups;
determining, via the model compression and tuning device, a similarity between each of the set of groups based on a cosine distance among them; and
determining, via the model compression and tuning device, a number of connections to be pruned from each of the set of groups based on the similarity and the pruning ratio.

4. The method of claim 1, wherein performing the rank-based factorization comprises:
applying, via the model compression and tuning device, a singular value decomposition on each of the set of target layers to generate singular value decomposition matrices (SVDMs) for each of the set of target layers, wherein the SVDMs comprises initial factorized weights for a given layer;
determining, via the model compression and tuning device, a rank for each of the set of target layers based on application of a pre-defined algorithm on singular values from the corresponding SVDMs, wherein the singular values are arranged in a ranked order; and
normalizing, via the model compression and tuning device, the rank for each of the set of target layers based on the initial rank to determine the factorized weights for each of the set of target layers of the LLM.

5. The method of claim 4, wherein performing the rank-based factorization comprises:
down-sampling, via the model compression and tuning device, the factorized weights for each of the set of target layers of the LLM based on the pruning ratio to compress the factorized weights for each of the set of layers of the LLM.

6. The method of claim 1, wherein updating the pruned LLM comprises:
generating, via the model compression and tuning device, an initial output for each of the one or more corresponding layers of the pruned LLM;
generating, via the model compression and tuning device, an additional output for each of the one or more additional layers; and
determining, via the model compression and tuning device, an output for each of the one or more corresponding layers of the pruned LLM based on the initial output and the additional output.

7. A system for compressing and tuning a large language model (LLM), comprising:
a processor;
a memory communicably coupled to the processor, wherein the memory stores processor-executable instructions, which, on execution, cause the processor to:
receive an LLM, a pruning ratio, an initial rank, and a set of target layers from a plurality of layers of the LLM;
perform a dependency-wise pruning of the LLM based on the pruning ratio to generate a pruned LLM;
perform a rank-based factorization of the LLM based on the initial rank to generate factorized weights for each of the set of target layers of the LLM; and
update the pruned LLM by injecting one or more additional layers to one or more corresponding layers of the pruned LLM to generate a compressed LLM,
wherein the one or more additional layers are based on the factorized weights for each of the set of target layers of the LLM.

8. The system of claim 7, wherein the processor is configured to:
fine-tune the compressed LLM for a specific domain or for a specific task by fine-tuning the factorized weights for the one or more additional layers of the compressed LLM based on the domain-specific training data or task-specific training data respectively.

9. The system of claim 7, wherein to perform the dependency-wise pruning, the processor is configured to:
group the dependent layers from the plurality of layers of the LLM, based on one or more parameters, into a set of groups;
determine a similarity between each of the set of groups based on a cosine distance among them; and
determine a number of connections to be pruned from each of the set of groups based on the similarity and the pruning ratio.

10. The system of claim 7, wherein to perform the rank-based factorization, the processor is configured to:
apply a singular value decomposition on each of the set of target layers to generate singular value decomposition matrices (SVDMs) for each of the set of target layers,
wherein the SVDMs comprises initial factorized weights for a given layer;
determine a rank for each of the set of target layers based on application of a pre-defined algorithm on singular values from the corresponding SVDMs,
wherein the singular values are arranged in a ranked order;
normalize the rank for each of the set of target layers based on the initial rank to determine the factorized weights for each of the set of target layers of the LLM.

11. The system of claim 10, wherein to perform the rank-based factorization, the processor is configured to:
down-sample the factorized weights for each of the set of target layers of the LLM based on the pruning ratio to compress the factorized weights for each of the set of layers of the LLM.

12. The system of claim 7, wherein to update the pruned LLM, the processor is configurable to:
generate an initial output for each of the one or more corresponding layers of the pruned LLM;
generate an additional output for each of the one or more additional layers; and
determine an output for each of the one or more corresponding layers of the pruned LLM based on the initial output and the additional output.

13. A non-transitory computer-readable medium storing computer-executable instructions for compressing and tuning a large language model (LLM), the computer-executable instructions configured for:
receiving an LLM, a pruning ratio, an initial rank, and a set of target layers from a plurality of layers of the LLM;
performing a dependency-wise pruning of the LLM based on the pruning ratio to generate a pruned LLM;
performing a rank-based factorization of the LLM based on the initial rank to generate factorized weights for each of the set of target layers of the LLM; and
updating the pruned LLM by injecting one or more additional layers to one or more corresponding layers of the pruned LLM to generate a compressed LLM,
wherein the one or more additional layers are based on the factorized weights for each of the set of target layers of the LLM.

14. The non-transitory computer-readable medium of claim 13, the computer-executable instructions are configured for:
fine-tuning the compressed LLM for a specific domain or for a specific task by fine-tuning the factorized weights for the one or more additional layers of the compressed LLM based on domain-specific training data or task-specific training data respectively.

15. The non-transitory computer-readable medium of claim 13, wherein to perform the dependency-wise pruning, the computer-executable instructions are configured for:
grouping dependent layers from the plurality of layers of the LLM, based on one or more parameters, into a set of groups;
determining a similarity between each of the set of groups based on a cosine distance among them; and
determining a number of connections to be pruned from each of the set of groups based on the similarity and the pruning ratio.

16. The non-transitory computer-readable medium of claim 13, wherein to perform the rank-based factorization, the computer-executable instructions are configured for:
applying a singular value decomposition on each of the set of target layers to generate singular value decomposition matrices (SVDMs) for each of the set of target layers, wherein the SVDMs comprises initial factorized weights for a given layer;
determining a rank for each of the set of target layers based on application of a pre-defined algorithm on singular values from the corresponding SVDMs, wherein the singular values are arranged in a ranked order; and
normalizing the rank for each of the set of target layers based on the initial rank to determine the factorized weights for each of the set of target layers of the LLM.

17. The non-transitory computer-readable medium of claim 16, wherein to perform the rank-based factorization, the computer-executable instructions are configured for:
down-sampling the factorized weights for each of the set of target layers of the LLM based on the pruning ratio to compress the factorized weights for each of the set of layers of the LLM.

18. The non-transitory computer-readable medium of claim 13, wherein to update the pruned LLM, the computer-executable instructions are configured for:
generating an initial output for each of the one or more corresponding layers of the pruned LLM;
generating an additional output for each of the one or more additional layers; and
determining an output for each of the one or more corresponding layers of the pruned LLM based on the initial output and the additional output.
